(19) United States
(12) Patent Application Publication
(10) Pub. No.: US 2014/0367891 A1
(43) Pub. Date: Dec. 18, 2014

(54) METHOD AND APPARATUS FOR MANUFACTURING GRAPHENE

(71) Applicants: Donald James Dawson, Paris, MI (US); Nijat Shujaat Zamanov, Baku (AZ)

(72) Inventors: Donald James Dawson, Paris, MI (US); Nijat Shujaat Zamanov, Baku (AZ)

(21) Appl. No.: 14/033,556

(22) Filed: Sep. 23, 2013

Related U.S. Application Data
(60) Provisional application No. 61/834,473, filed on Jun. 13, 2013.

(51) Int. Cl. C01B 31/04

(52) U.S. Cl. CPC C01B 31/0453
USPC 264/402; 425/150; 264/40.1

(57) ABSTRACT

A method and apparatus for manufacturing graphene including rotating a continuous surface within an evacuated chamber; coating the surface with a catalyst layer; heating portions of the catalyst layer; coating the heated portions of the catalyst layer with one or more layers of graphene; monitoring grain growth of the graphene layer; if the monitored grain growth indicates unacceptable grain growth, then taking corrective action; and removing the catalyst layer and the layer of graphene from the surface by heating other portions of the catalyst layer.

### 1. CROSS REFERENCE TO RELATED APPLICATIONS

This application claims the benefit of the filing date of U.S. provisional patent application Ser. No. 61/834,473, filed on Jun. 13, 2013, the disclosure of which is incorporated herein by reference.

### 2. BACKGROUND

This disclosure relates to methods and apparatus for manufacturing graphene.

### BRIEF DESCRIPTION OF THE DRAWINGS

FIG. 1 is an illustration of an exemplary embodiment of a system for manufacturing graphene.

FIG. 2 is an illustration of an exemplary embodiment of a portion of the system of FIG. 1.

FIG. 3 is an illustration of an exemplary embodiment of a portion of the system of FIG. 1.

FIG. 4 is an illustration of an exemplary embodiment of a portion of the system of FIG. 1.

FIG. 5 is an illustration of an exemplary embodiment of a portion of the system of FIG. 1.

FIG. 6 is an illustration of an exemplary embodiment of a portion of the system of FIG. 1.

FIG. 7 is an illustration of an exemplary embodiment of a portion of the system of FIG. 1.

FIG. 8 is an illustration of an exemplary embodiment of a portion of the system of FIG. 1.

FIG. 9 is an illustration of an exemplary embodiment of a portion of the system of FIG. 1.

FIG. 10 is an illustration of an exemplary embodiment of a portion of the system of FIG. 1.

FIG. 11 is an illustration of an exemplary embodiment of a portion of the system of FIG. 1.

FIG. 12 is an illustration of an exemplary embodiment of a portion of the system of FIG. 1.

FIG. 13 is an illustration of an exemplary embodiment of a portion of the system of FIG. 1.

FIGS. 14a-14e are flow chart illustrations of an exemplary embodiment of a method of operating the system of FIGS. 1-13.

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

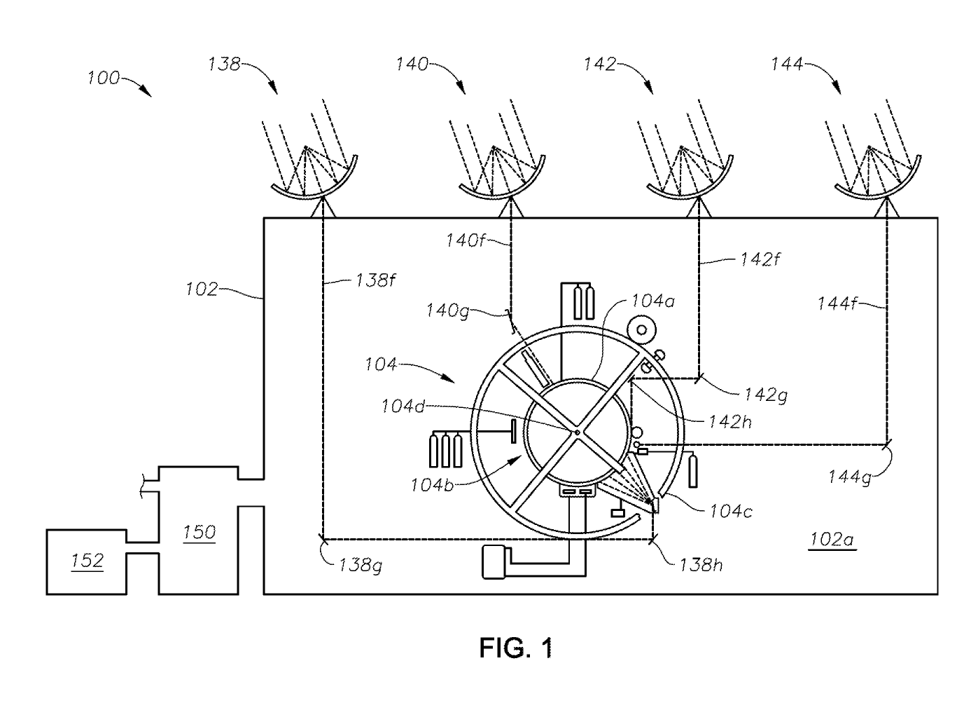

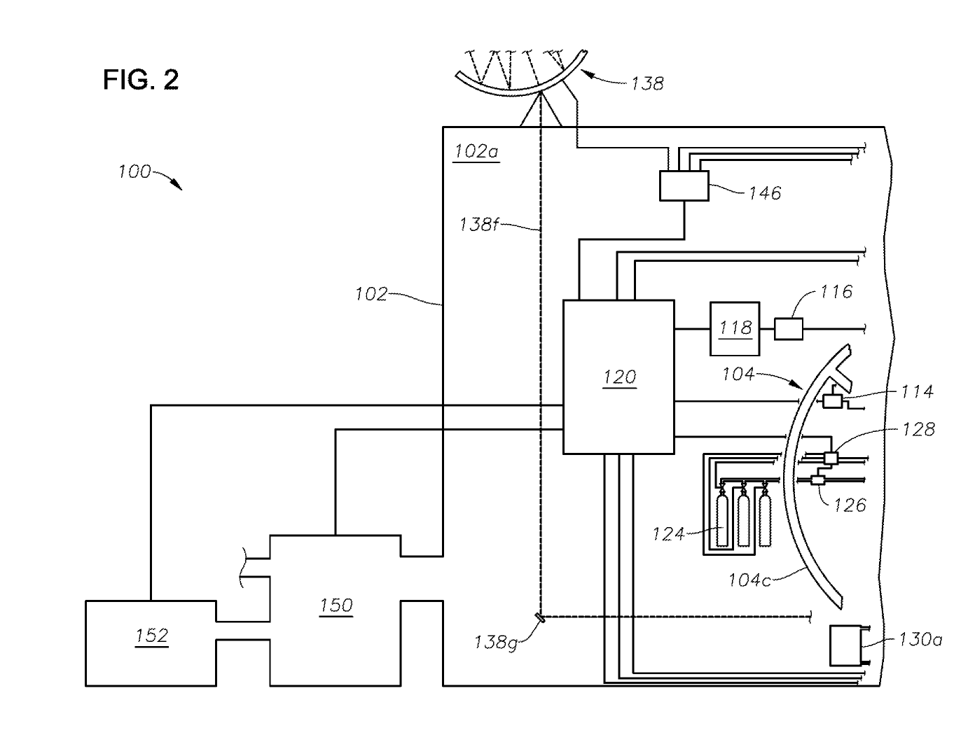

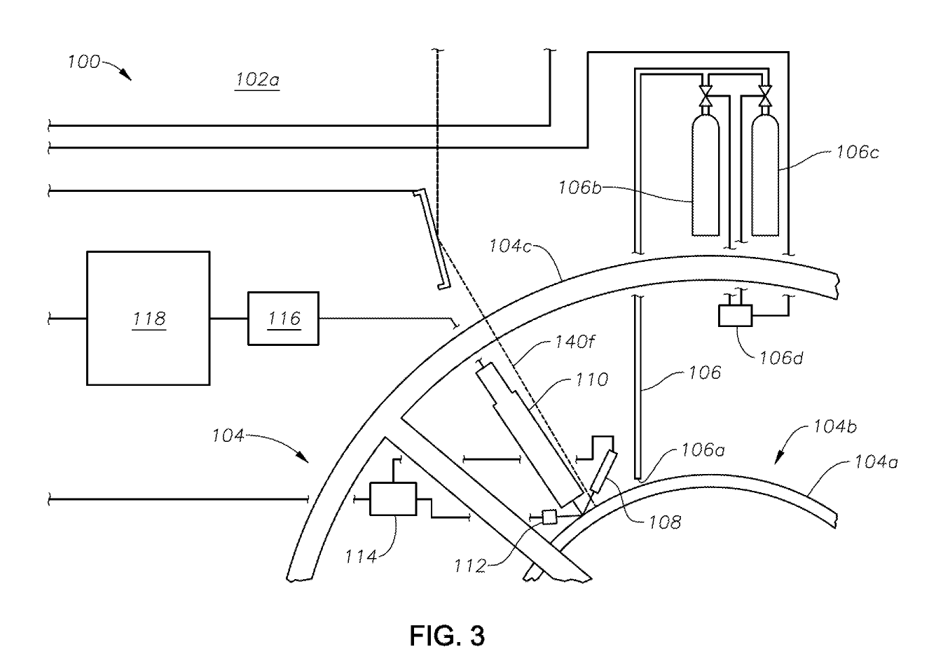

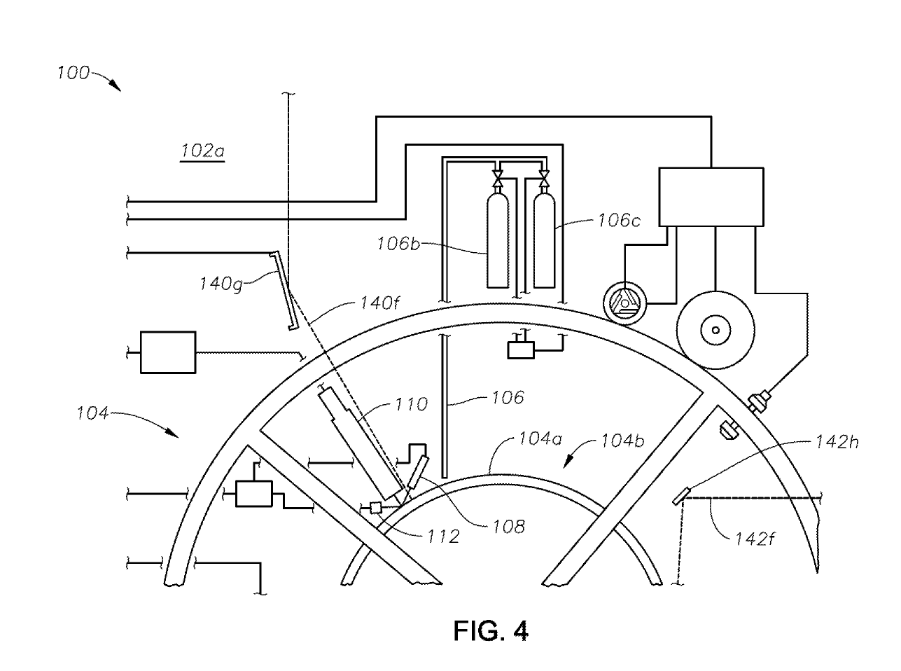

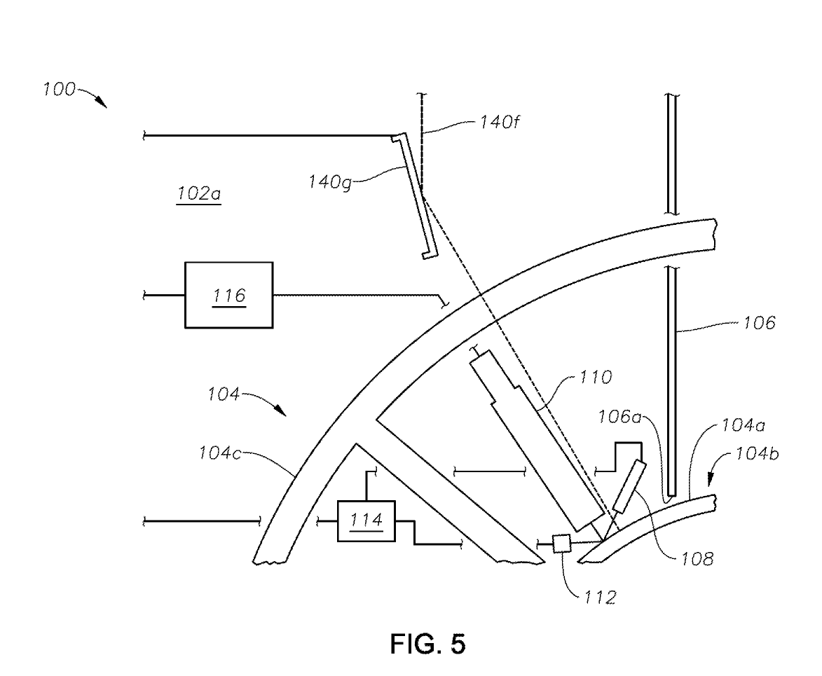

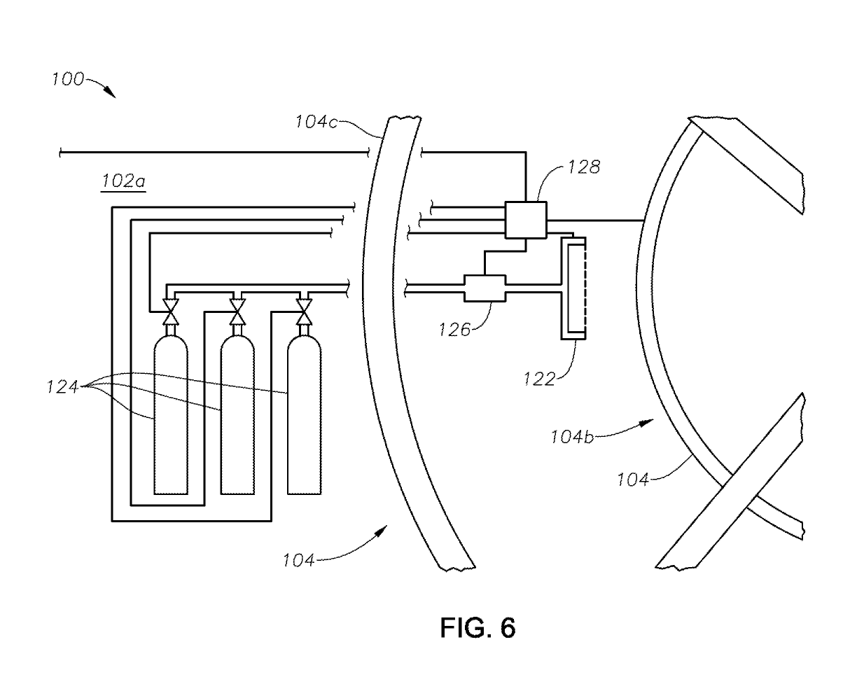

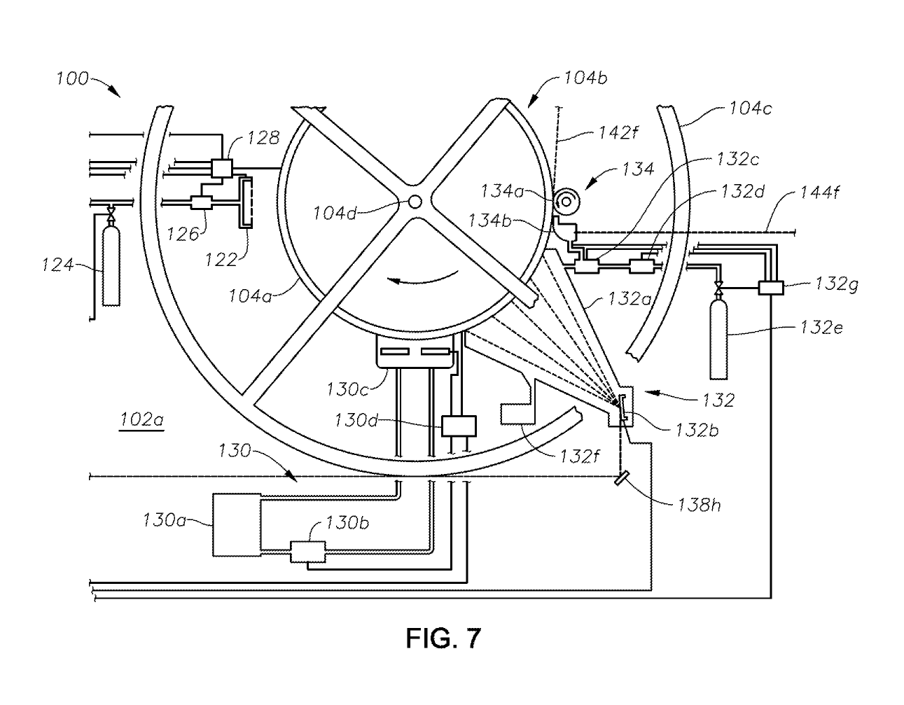

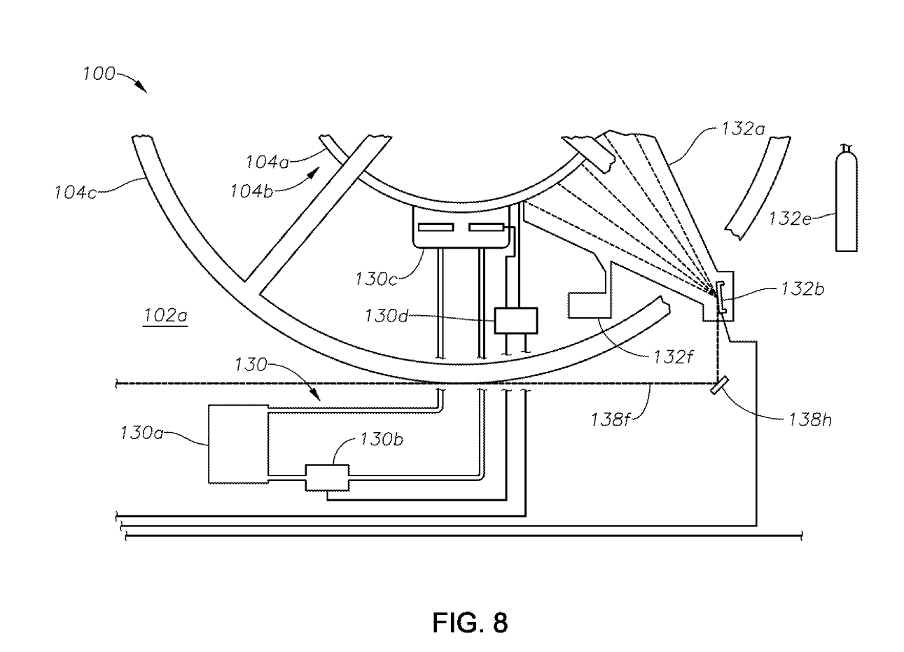

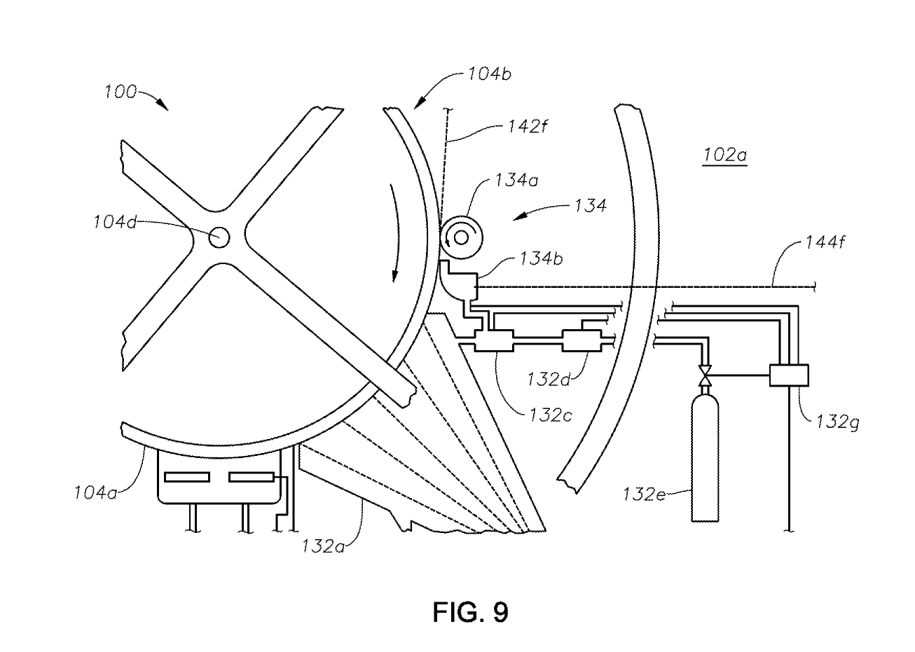

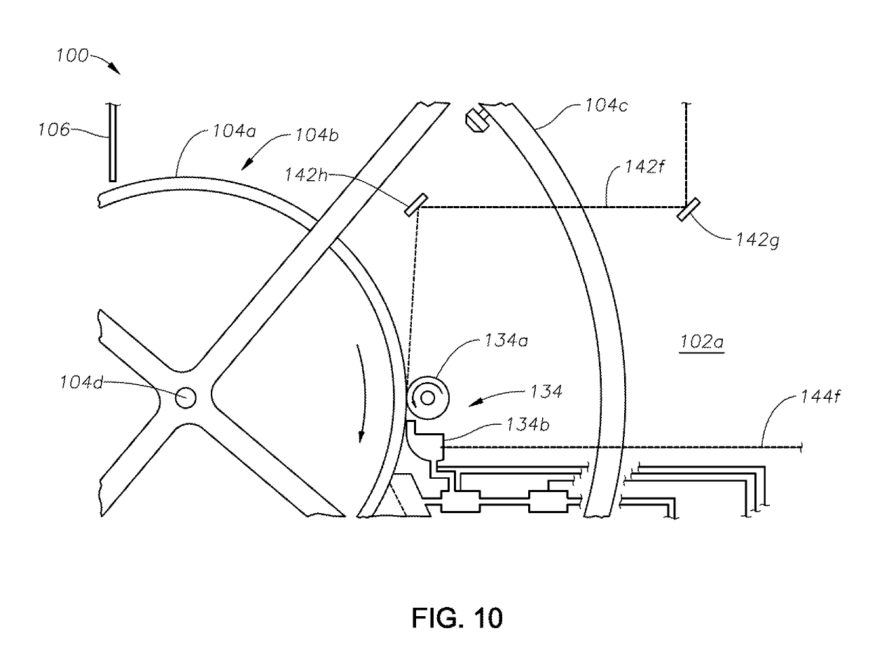

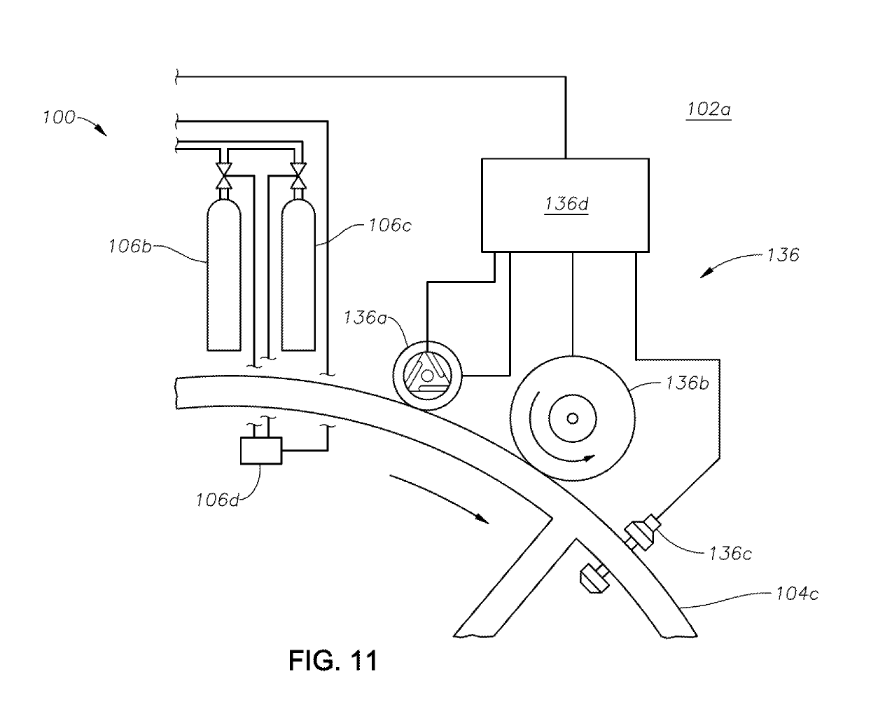

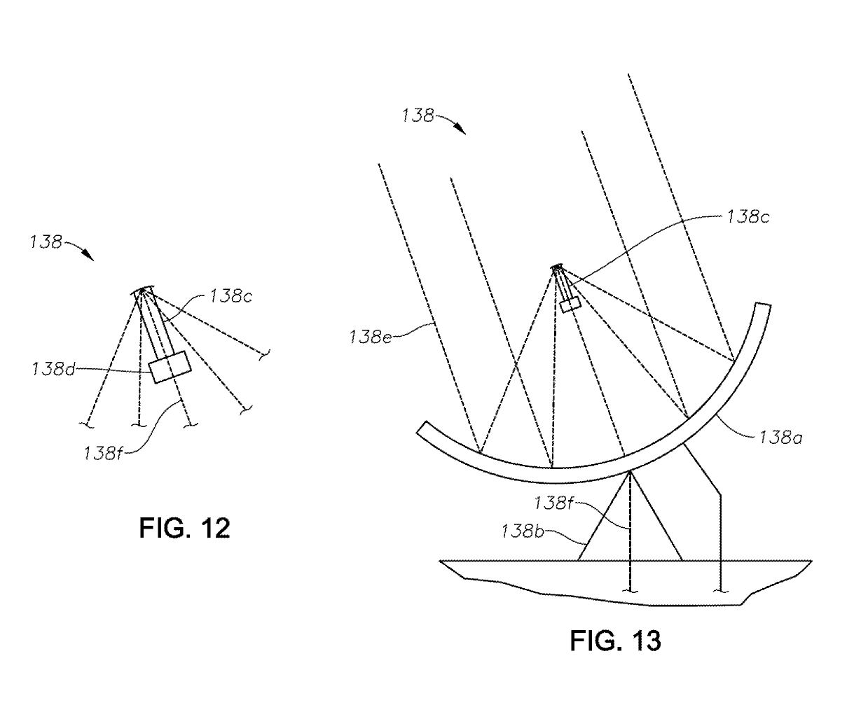

Referring to FIGS. 1-13, an exemplary embodiment of a system 100 for manufacturing graphene includes a housing 102 that defines a chamber 102a. Positioned and supported for rotation within the chamber 102a of the housing 102 is a drum assembly 104 that includes a cylindrical drum 104a having an external cylindrical surface 104b, an outer ring 104c coupled to the cylindrical drum and an axis of rotation 104d.

In an exemplary embodiment, an pipe 106 having an open end 106a proximate a portion of the surface 104b of the drum 104a extends into the chamber 102a for providing a source of carbon by injecting CH₄ and H₂ onto the surface of the drum. In an exemplary embodiment, the opposite end of the pipe 106 is controllably coupled to sources, 106b and 106c, of CH₄ and H₂ by a controller 106d.

In an exemplary embodiment, a conventional raman spectroscopy laser 108, a conventional scanning electric microscope 110 and a conventional raman spectroscopy detector 112 are positioned proximate another portion of the surface 104b of the drum 104a within the chamber 102a adjacent to the open end 106a for monitoring the surface features of materials on the drum. In an exemplary embodiment, the raman spectroscopy laser 108 and the raman spectroscopy detector 112 a permit detection of a leading edge of grain growth in a layer of graphene and the scanning electric microscope 110 permits differences in the grains and grain growth. In an exemplary embodiment, a tunneling electron microscope may be substituted for, or used in addition to, the scanning electric microscope 110. In an exemplary embodiment, a conventional raman spectroscopy controller 114 is operably coupled to the raman spectroscopy laser 108 and the raman spectroscopy detector 112, and a conventional scanning electron microscope controller 116 is operably coupled to the scanning electron microscope 110. In an exemplary embodiment, the scanning electron microscope controller 116 is operably coupled to a conventional scanning electron microscope image processor 118 and the scanning electron microscope image processor and the raman spectroscopy controller 114 are operably coupled to a main processor 120. In an exemplary embodiment, the main processor 120 may include one or more conventional programmable general purpose computers, one or more conventional memory devices, and one or more conventional interfaces to a local area network, wide area network, and/or the Internet.

In an exemplary embodiment, a conventional plasma chemical vapor deposition (“CVD”) device 122 is positioned proximate another portion of the surface 104b of the drum 104a within the chamber 102a for depositing one or more layers of materials onto the surface of the drum. In an exemplary embodiment, the CVD device 122 is coupled to a source of one or more chemical materials 124 by a conventional mass flow controller (“MFC”) 126 and the CDV device and the MFC are operably coupled to a conventional plasma CVD controller 128. In an exemplary embodiment, the MFC 126 and the CVD controller 128 are operably coupled to the main processor 120. In an exemplary embodiment, the plasma chemical vapor deposition (“CVD”) device 122 is operated to apply a layer of TiSiN onto the surface of the drum 104a.

In an exemplary embodiment, a conventional electro-polishing assembly 130 is positioned proximate another portion of the surface 104b of the drum 104a within the chamber 102a for electro-polishing one or more layers of materials on the surface of the drum. In an exemplary embodiment, the electro-polishing assembly 130 includes an electro-polishing solution tank 130a, a polishing solution pump 130b, and cathodes 130c that are operably coupled to an electro-polishing controller 130d. In an exemplary embodiment, the electro-polishing controller 130d is operably coupled to the main processor 120. In an exemplary embodiment, the electro-polishing assembly 130 is operated to chemically polish a layer of copper (111) deposited on the outer surface 104b of the drum 104a.

In an exemplary embodiment, a chemical vapor deposition (“CVD”) assembly 132 is positioned proximate another portion of the surface 104b of the drum 104a within the chamber 102a for depositing one or more layers of materials onto the surface of the drum. In an exemplary embodiment, the CVD assembly 132 includes a shroud 132a for covering and isolating a portion of the surface 104b of the drum 104a, a conventional piezoelectric mirror 132b, positioned within the shroud, for directing concentrated sunlight onto the surface of the drum and thereby heating the surface of the drum. In an exemplary embodiment, the CVD assembly 132 further includes a conventional copper reconditioner 132c, a conventional mass flow controller 132d, a source of gaseous materials 132e, a by-product collection area 132f, and a conventional CVD controller 132g. In an exemplary embodiment, the copper reconditioner 132c is adapted to collect copper materials, which may be recycled, and prepare them for depositing on the surface of the drum 104b of the drum 104a. In an exemplary embodiment, the mass flow controller 132d controls the flow of gaseous materials from the source of gaseous materials 132e, and the piezoelectric mirror 132b, the copper reconditioner 132c and the mass flow controller are operably coupled to the CVD controller 132g. In an exemplary embodiment, the by-product collection area 132f is coupled to a lower portion of the shroud 132a and is adapted to collect by-products of the CVD process during operation of the CVD assembly 132. In an exemplary embodiment, the CVD assembly 132 is operated to apply a layer of copper (111) onto the surface 104b of the drum 104a. In an exemplary embodiment, the CVD controller 132g is operably coupled to the main processor 120.

In an exemplary embodiment, a graphene removal assembly 134 is positioned proximate another portion of the surface 104b of the drum 104a within the chamber 102a for removing a layer of graphene from the surface 104b of the drum 104a. In an exemplary embodiment, the assembly 134 includes a graphene collector roller 134a for rolling the graphene layer removed from the surface 104b of the drum 104a onto the roller and a melted copper collector 134b for collecting copper (111) material removed from the surface of the drum into the collector 134b so the removed copper (111) may be recycled and recoated onto the surface of the drum by operating the CVD assembly 132. In an exemplary embodiment, the graphene removal assembly 134 is operated to remove the layer of graphene from the surface 104b of the drum 104a by melting an underlying layer of copper (111) from the surface of the drum.

In an exemplary embodiment, a drum rotation control assembly 136 is positioned proximate another portion of the surface 104b of the drum 104a within the chamber 102a for controlling rotation of the drum 104a. In an exemplary embodiment, the drum rotation control assembly 136 includes a piezoelectric drive motor 136a, a high speed drive motor 136b, and a brake 136c that are all operably coupled to a drum drive controller 136d. In an exemplary embodiment, the drum drive controller 136d is operably coupled to the main processor 120. In an exemplary embodiment, the piezoelectric drive motor 136a is adapted to make high precision and high resolution movements of the drum 104a, the high speed drive motor 136b is adapted to make high speed and large movements of the drum, and the brake 136c is adapted to stop rotation of the drum.

A plurality of optical collection assemblies, 138, 140, 142 and 144, are provided that permit collection and concentration of lightwaves to permit heating of various portions of the outer surface 104b of the drum 104a within the chamber 102a. In an exemplary embodiment, the design and operation of the optical collection assemblies, 138, 140, 142 and 144, are substantially identical.

In an exemplary embodiment of the optical collection assembly 138 includes a DLP mirror dish 138a that is mounted onto a dish mount and rotating motor assembly 138b, a reflector 138c, and a reflector focus lens 138d. In an exemplary embodiment, the DLP mirror dish 138a includes a plurality of controllable DLP mirrors that reflect incident sunlight 138e onto the reflector 138c and then the sunlight is reflected off of the reflector through the reflector focus lens 138d. In this manner, the optical collection assembly 138 controllably collects and concentrates incident sunlight to generate a powerful and concentrated ray of light 138f that may be further guided and reflected and then focused on a selected portion of the surface 104b of the drum 104a to thereby heat the selected portion of the surface of the drum. Furthermore, in an exemplary embodiment, the DLP mirrors of the DLP mirror dish 138a may be operated to reflect more or less of the incident sunlight 138e onto the reflector 138c. Thus, the optical power output of the assembly 138 may be precisely controlled to transmit anywhere from zero to the maximum amount of output.

In an exemplary embodiment, optical collection assemblies, 138, 140, 142 and 144, thereby generate concentrated rays of light, 138f, 140f, 142f, and 144f, respectively, that may be transmitted into the chamber 102a and then further guided and reflected and then focused on corresponding selected portions of the surface 104b of the drum 104a to thereby heated the selected portions of the surface of the drum. In an exemplary embodiment, the optical collection assemblies, 138, 140, 142 and 144, are operably coupled to a DLP mirror controller 146, and the DLP mirror controller is operably coupled is operably coupled to the main processor 120. In an exemplary embodiment, one or more lasers may be substituted for one or more of the optical collection assemblies, 138, 140, 142 and 144.

In an exemplary embodiment, the light ray 138f enters the chamber 102a and is reflected by mirrors, 138g and 138h, which may or may not be piezoelectric, and then reflects off of the piezoelectric mirror 132b of the CVD assembly 132 and thereby controllably directed onto selected portions of the outer surface 104b of the drum 104a within the shroud 132a. In an exemplary embodiment, the CVD assembly 132 operates to deposit a coating of copper (111) onto the outer surface 104b of the drum 104a. In an exemplary embodiment, the piezoelectric mirror 132b of the CVD assembly 132 may be operated to controllably scan the outer surface 104b of the drum 104a within the shroud 132a to thereby heat substantially all of such outer surface covered by the shroud.

In an exemplary embodiment, the light ray 140f enters the chamber 102a and is reflected by piezoelectric mirror 140g, which may or may not be piezoelectric, and then reflects off of the piezoelectric mirror and thereby controllably directed onto selected portions of the outer surface 104b of the drum 104a proximate the portion of the outer surface 104b of the drum 104a that is monitored by the scanning electron microscope 110. In an exemplary embodiment, the piezoelectric mirror 140g is operably coupled to the main processor 120. In an exemplary embodiment, the light ray 140f heats a selected portion of the outer surface 104b of the drum 104a, that already includes a coating of copper (111), in the presence of CH₄ and H₂ gases. As a result, a layer of graphene is deposited on the layer of copper (111). In an exemplary embodiment, the piezoelectric mirror 140g may be operated to scan the surface 104b of the drum 104a thereby permitting any portion of the outer surface to be heated. As a result, the portion of the surface 104b of the drum 104a that may be coated with graphene may be controlled thereby.

In an exemplary embodiment, the light ray 142f enters the chamber 102a and is reflected by mirrors, 142g and 142h, which may or may not be piezoelectric, and thereby is directed onto selected portions of the outer surface 104b of the drum 104a proximate the portion of the outer surface 104b of the drum 104a that immediately adjacent to and in contact with the outer surface of the graphene collector roller 134a. In an exemplary embodiment, the light ray 142f thereby heats and melts a layer of copper (111) underlying a layer of graphene deposited thereon. As a result, the layer of copper (111) is melted and the layer of graphene is rolled onto the outer surface of the graphene collector roller 134a.

In an exemplary embodiment, the light ray 144f enters the chamber 102a and is reflected by mirror 144g, which may or may not be piezoelectric, and thereby is directed onto selected portions of the copper (111) collector 134b to thereby re-melt the collected copper (111) and permit the copper (111) to be processed by the copper reconditioner 132c.

In an exemplary embodiment, a vacuum pump 150 may be coupled to the chamber 102a of the housing 102 for evacuating the interior volume of the chamber 102b. In an exemplary embodiment, the vacuum pump 150 is operably coupled to the main processor 120. In an exemplary embodiment, a fuel cell 152 is operably coupled to the system 100 for providing power for in the system.

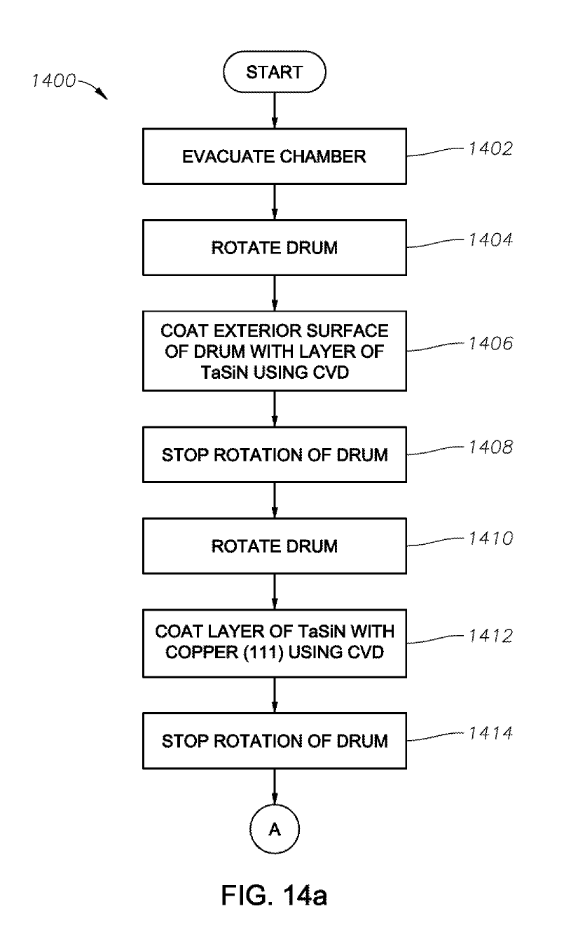

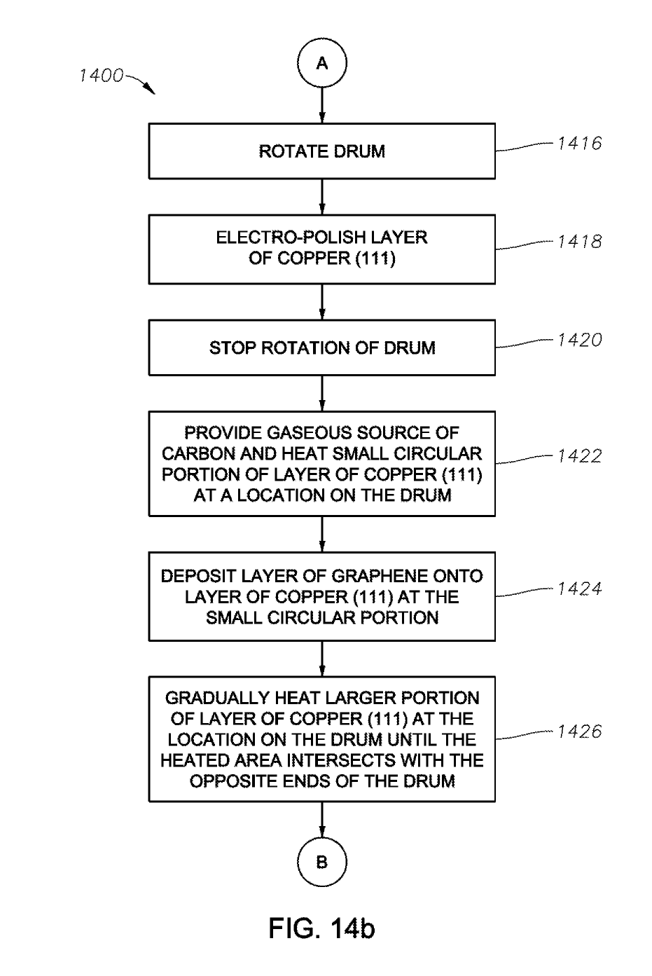

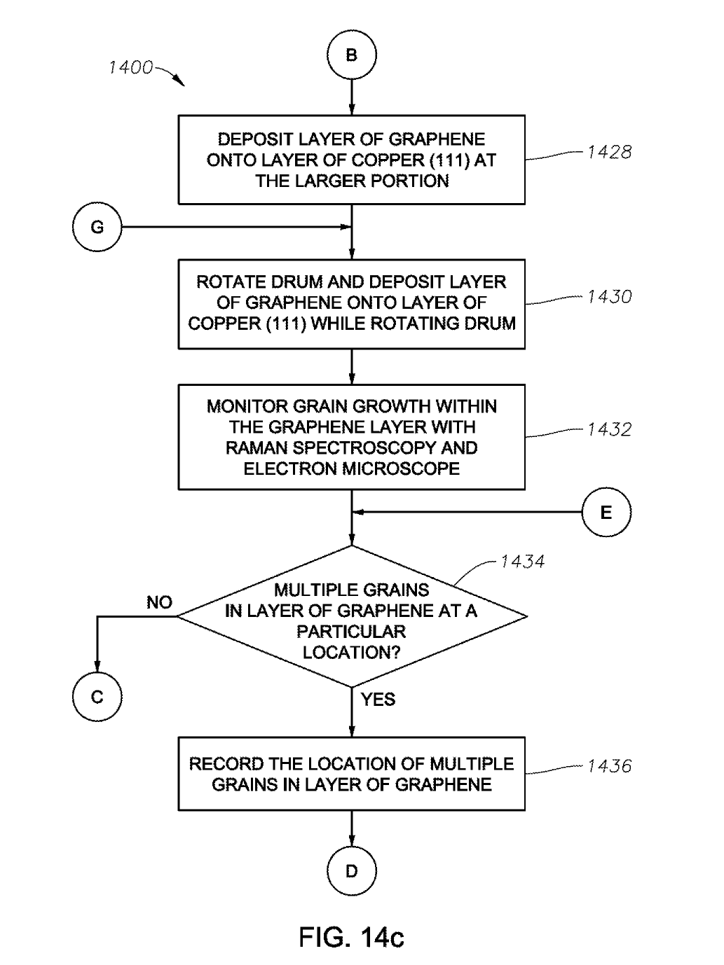

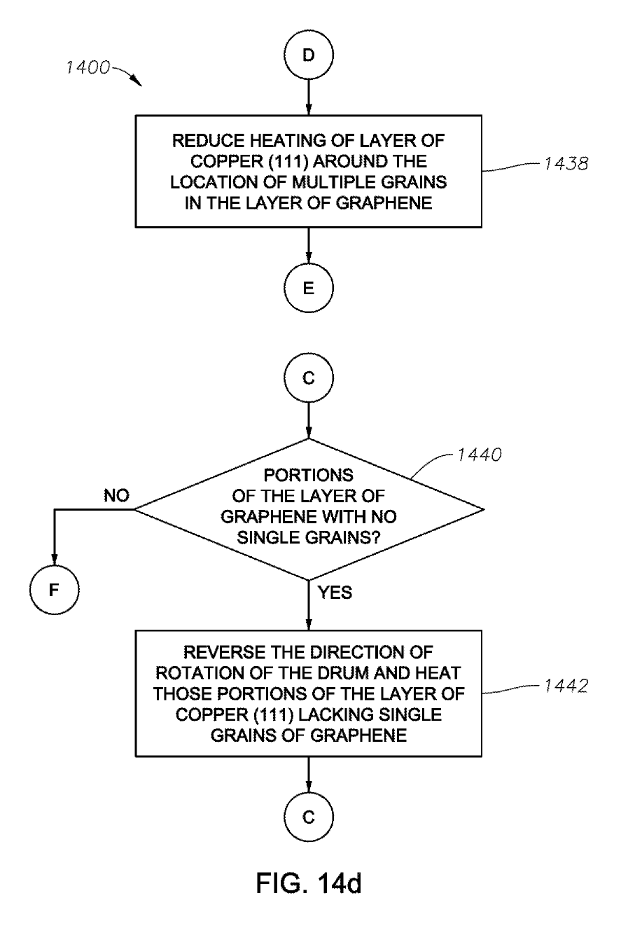

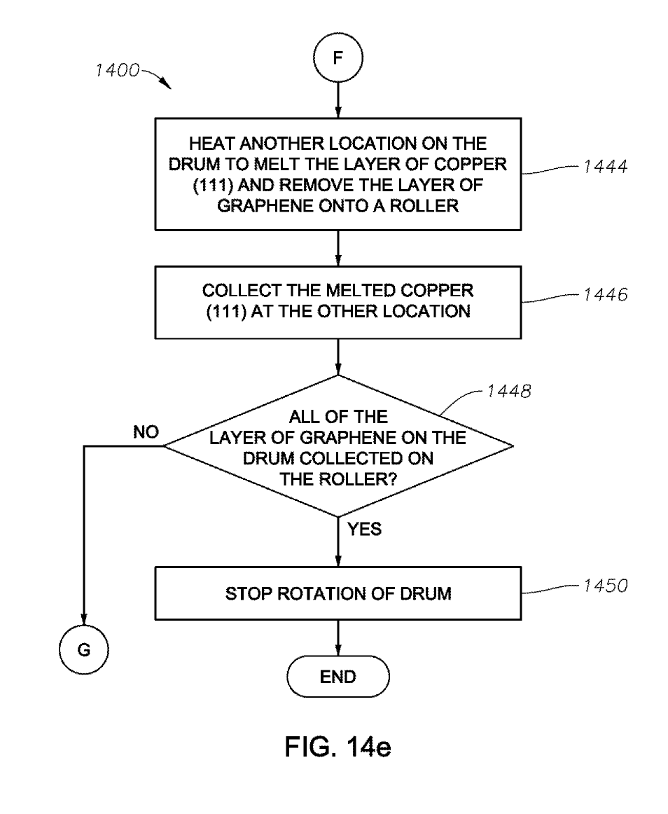

Referring now to FIGS. 14a-14e, in an exemplary embodiment, the main processor 120 is adapted to control the operation of the system 100 and thereby implement a method of operation 1400 in which, in 1402, the vacuum pump 150 is operated to evacuate the chamber 102a. In an exemplary embodiment, in 1404, the drum drive controller 136d is then operated to rotate the drum 104a in a counter-clockwise direction by operating the piezoelectric drive motor 136a and/or the high speed drive motor 136b.

In an exemplary embodiment, in 1406, the plasma CVD controller 128 is then operated to deposit a coating of TᵢSᵢN on the outer surface 104b of the drum 104a. In an exemplary embodiment, in 1404, the drum drive controller 136d is then operated to stop the rotation of the drum 104a by operating the brake 136c. In an exemplary embodiment, in 1410, the drum drive controller 136d is then operated to rotate the drum 104a in a counter-clockwise direction by operating the piezoelectric drive motor 136a and/or the high speed drive motor 136b.

In an exemplary embodiment, in 1412, the CVD assembly 132 is then operated to deposit a layer of copper (111) onto the layer of TSN on the outer surface 104b of the drum 104a. In an exemplary embodiment, in 1414, the drum drive controller 136d is then operated to stop the rotation of the drum 104a by operating the brake 136c.

In an exemplary embodiment, in 1416, the drum drive controller 136d is then operated to rotate the drum 104a in a counter-clockwise direction by operating the piezoelectric drive motor 136a and/or the high speed drive motor 136b. In an exemplary embodiment, in 1418, the electro-polishing assembly 130 is operated to chemically polish the layer of copper (111). In an exemplary embodiment, in 1420, the drum drive controller 136d is then operated to stop the rotation of the drum 104a by operating the brake 136c.

In an exemplary embodiment, in 1422, the CVD controller 106d is operated to release a gaseous mixture of CH₄ and H₂ from the open end of the pipe 106, the DLP mirror controller 146 is operated to generate the light ray 140f, and the piezoelectric mirror 140g is operated to heat a small circular portion of the layer of copper (111) deposited on the outer surface 104b of the drum 104a. In this manner, in 1424, a layer of graphene is thereby deposited on the heated small circular portion of the layer of copper (111) deposited on the outer surface 104b of the drum 104a.

In an exemplary embodiment, in 1426, the piezoelectric mirror 140g is then operated to heat a larger circular portion of the layer of copper (111) deposited on the outer surface 104b of the drum 104a such that the larger circular portion overlaps with the opposite edges of the outer surface 104b of the drum 104a. In this manner, in 1428, a layer of graphene is thereby deposited on the heated larger circular portion of the layer of copper (111) deposited on the outer surface 104b of the drum 104a such that the layer of deposited graphene covers the full length of the outer surface of the drum.

In an exemplary embodiment, in 1430, the drum drive controller 136d is then operated to rotate the drum 104a in a counter-clockwise direction by operating the piezoelectric drive motor 136a and/or the high speed drive motor 136b. In this manner, a layer of graphene may be deposited along the entire length of the outer surface 104b of the drum 104a while the drum is rotated.

In an exemplary embodiment, in 1432, as the layer of graphene is deposited on the layer of copper (111) while the drum is rotated 104a, the raman spectroscopy controller 114 and the electron microscope controller 116 are operated to detect and monitor grain growth within the deposited layer of graphene. In an exemplary embodiment, in 1434, if the raman spectroscopy controller 114 and the electron microscope controller 116 detect multiple grains in the layer of graphene at a particular location on layer of copper (111) on the outer surface 104b of the drum 104a, then the particular location of the multiple grains is recorded and then, in 1438, heating of the layer of copper (111) around the particular location of the multiple grains is reduced by operating the DLP mirror controller 146 to reduce the intensity of the light ray 140f around the particular location of the multiple grains to thereby isolate the growth of multiple grains in the layer of graphene. In an exemplary embodiment, during 1432, 1434, and 1436, the processor 120 creates a database that includes the grain distribution, structure, purity, impurity, and location of such indicia within the graphene as well as all of the data generated by the raman spectroscopy controller 114 and the electron microscope controller 11. In this manner, the information regarding the graphene may be provided to the end user in order to more effectively further process the graphene to manufacture various end products.

In an exemplary embodiment, in 1434, if the raman spectroscopy controller 114 and the electron microscope controller 116 do not detect multiple grains in the layer of graphene at a particular location on layer of copper (111) on the outer surface 104b of the drum 104a, then the raman spectroscopy controller 114 and the electron microscope controller 116 are operated to detect portions of the layer of graphene on the layer of copper (111) with no single grains in 1440. In an exemplary embodiment, if the raman spectroscopy controller 114 and the electron microscope controller 116 detect portions of the layer of graphene on the layer of copper (111) with no single grains in 1440, then the drum drive controller 136d is then operated to rotate the drum 104a in a clockwise direction by operating the piezoelectric drive motor 136a and/or the high speed drive motor 136b and the piezoelectric mirror 140g is operated to heat those portions of the layer of copper (111) lacking single grains of graphene.

In this manner, in an exemplary embodiment, in 1434, 1436, 1438, 1440, and 1442, the system 100 provides a continuous sheet of graphene on the layer of copper (111) by operating the raman spectroscopy controller 114 and the electron microscope controller 116, the piezoelectric drive motor 136a and/or the high speed drive motor 136b, and the piezoelectric mirror 140g to controllably deposit single grains of graphene in a continuous layer onto the layer of copper (111). More generally, due to the control and operation of the raman spectroscopy controller 114 and the electron microscope controller 116, the piezoelectric drive motor 136a and/or the high speed drive motor 136b, and the piezoelectric mirror 140g, the system may precisely deposit a continuous layer of single grain graphene onto the layer of copper (111).

In an exemplary embodiment, in 1444, the DLP mirror controller 146 is operated to generate the light ray 142f to thereby melt the layer of copper (111) and collect the overlying layer of graphene onto the roller 134a. In an exemplary embodiment, the melted portion of the layer of copper (111) is collected in the copper collector 134b in 1446. In an exemplary embodiment, the melted copper (111) that is collected may be re-melted by operation of the light ray 144f and then reconditioned within the copper reconditioner 132c for subsequent use in depositing a layer of copper (111) onto the outer surface 104b of the drum 104a.

If all of the layer of graphene has been collected onto the roller 134a in 1448, then, in an exemplary embodiment, in 1450, the drum drive controller 136d is then operated to stop the rotation of the drum 104a by operating the brake 136c.

In an exemplary embodiment, other materials may be substituted for the layer of copper (111) such as, for example, nickel and/or silicon, and equivalent materials. In an exemplary embodiment, the system 100 operates multiple CVD (having plasma and substrate heating) systems to deposit substrates that will provide the highest purity graphene layer deposited thereon. In an exemplary embodiment, all such substrates are layered onto the outer surface 104b of the drum 104a while it rotates and passes through multiple CVDs. In an exemplary embodiment, because the CVD of copper is electromagnetic, it can be controlled thereby further controlling the growth of graphene thereon. In an exemplary embodiment, copper (111) produces the most uniform grain in the graphene and would be used for a high production system. In an exemplary embodiment, the system 100 provides a mass production CVD system that is capable of producing a continuous sheet of graphene. Furthermore, because the system 100 has multiple different CVD processes, the present system permits printing graphene like a 3D.

In an exemplary embodiment, substrates such as, for example, SiO₂, SS, Ti, and/or graphene may be layered onto the outer surface 104b of the drum 104a in order to grow a nanoforest instead of, or in addition to, graphene. In this manner, we may pull the nanotubes out of the forest and make nanoyarn out of the nanotubes. Furthermore, in this manner, we may grow a continuous nanoforest onto the outer surface 104b of the drum 104a. Furthermore, if one of the pulling systems, e.g., a rotating motor, is placed in the chamber 102a of the system 100 it can pull from the leading edge of the nanoforest while electromagnetic energy grows the nanoforest at the trailing edge. In this manner, the system 100 may be operated to create a continuous nanotube forest. Furthermore, in this manner, nanoyarn may be spun within the chamber 102a of the system 100 while still in the vacuum within the chamber from a continuous nanoforest.

In an exemplary embodiment, a method of manufacturing graphene has been described that includes rotating a drum within an evacuated chamber; coating the drum with a layer of TaSiN; coating the layer of TaSiN on the drum with a layer of copper (111); electro-polishing the layer of copper (111); heating portions of the layer of copper (111) using focused sunlight; coating the heated portions of the layer of copper (111) on the drum with a layer of graphene; monitoring grain growth of the graphene layer; if the monitored grain growth of the graphene layer indicates more than one grain at a particular location, then reducing heating of the particular location to isolate the grain growth of the particular location and recording the particular location in a memory; if the monitored grain growth of the graphene layer indicates a single grain surrounded by another single grain at another particular location, then controlling the direction of the rotation of the drum to permit any portions of the layer of copper (111) proximate the particular location missing a grain of graphene to grow a grain of graphene; and removing the layer of copper (111) and the layer of graphene from the layer of TaSiN on the drum by heating other portions of the layer of copper (111) using focused sunlight. In an exemplary embodiment, heating portions of the layer of copper (111) using focused sunlight comprises controllably focusing concentrated sunlight at a small circular area on the layer of copper (111); and then increasing the diameter of the heated area on the layer of copper (111) until the heated area includes the opposite edges of the layer of copper (111) on the drum. In an exemplary embodiment, coating the heated portions of the layer of copper (111) on the drum with a layer of graphene comprises rotating the drum after the heated area includes the opposite edges of the layer of copper (111) on the drum. In an exemplary embodiment, monitoring the grain growth of the graphene layer comprises raman spectroscopy of the graphene layer. In an exemplary embodiment, monitoring the grain growth of the graphene layer comprises scanning the graphene layer with an electron microscope. In an exemplary embodiment, removing the layer of copper (111) and the layer of graphene from the layer of TaSiN on the drum by heating other portions of the layer of copper (111) using focused sunlight comprises: melting the layer of copper (111); and rolling the layer of graphene onto a roller wheel. In an exemplary embodiment, the method further includes collecting the melted copper (111); and recycling the collected copper (111).

A method of manufacturing graphene has been described that includes rotating a drum within an evacuated chamber; coating the drum with a catalyst layer; heating portions of the catalyst layer; coating the heated portions of the catalyst layer with a layer of graphene; monitoring grain growth of the graphene layer; if the monitored grain growth indicates unacceptable grain growth, then taking corrective action; and removing the catalyst layer and the layer of graphene from the drum by heating other portions of the catalyst layer. In an exemplary embodiment, heating portions of the catalyst layer comprises heating portions of the catalyst layer using electromagnetic energy. In an exemplary embodiment, heating portions of the layer of the catalyst layer using electromagnetic energy comprises controllably focusing electromagnetic energy at a small circular area on the catalyst layer; and then increasing the diameter of the heated area on the catalyst layer until the heated area includes the opposite edges of the catalyst layer on the drum. In an exemplary embodiment, coating the heated portions of the catalyst layer on the drum with a layer of graphene comprises rotating the drum after the heated area includes the opposite edges of the catalyst layer on the drum. In an exemplary embodiment, monitoring the grain growth of the graphene layer comprises raman spectroscopy of the graphene layer. In an exemplary embodiment, if the monitored grain growth indicates unacceptable grain growth, then taking corrective action comprises: if the monitored grain growth of the graphene layer indicates more than one grain at a particular location, then reducing heating of the particular location to isolate the grain growth of the particular location; if the monitored grain growth of the graphene layer indicates a single grain surrounded by another single grain at another particular location, then controlling the direction of the rotation of the drum to permit any portions of the catalyst layer proximate the particular location missing a grain of graphene to grow a grain of graphene.

A system for manufacturing graphene has been described that includes a housing defining a chamber; a rotable drum positioned within the chamber having an exterior surface coated with a catalyst layer; a motor operably coupled to the drum; a motor controller operably coupled to the motor for controlling a rate and direction of rotation of the drum; a source of carbon positioned within the chamber proximate the drum; a first heating source for heating a first exterior portion of the catalyst layer on the drum; a monitoring device positioned proximate the first exterior portion of the drum for monitoring a grain growth of graphene on the exterior portion of the catalyst layer on the drum; a second heating device for heating a second exterior portion of the catalyst layer on the drum; and a controller operably coupled to the motor, the source of carbon, the first heating source and the second heating source; wherein the controller is adapted to control the direction and rate of rotation of the motor as a function of the grain growth of graphene on the exterior portion of the catalyst layer on the drum. In an exemplary embodiment, the catalyst layer comprises copper (111). In an exemplary embodiment, the first heating source comprises electromagnetic energy. In an exemplary embodiment, the monitoring device comprises raman spectroscopy. In an exemplary embodiment, the monitoring device comprises an electron microscope. In an exemplary embodiment, the second heating source comprises electromagnetic energy. In an exemplary embodiment, the controller is adapted to reverse the direction of the rotation of the drum in order to ensure complete coverage of the catalyst layer with graphene. In an exemplary embodiment, the controller is adapted to record locations of the layer of graphene having multiple grains. In an exemplary embodiment, the system further includes a plurality of CVD assemblies operably coupled to the controller that are deposit one or more layers on materials onto the exterior surface of the drum.

A method of 3D printing graphene has been described that includes rotating a drum within an evacuated chamber; coating the drum with a catalyst layer; heating portions of the catalyst layer; coating the heated portions of the catalyst layer with one or more layers of graphene; monitoring grain growth of the graphene layer; if the monitored grain growth indicates unacceptable grain growth, then taking corrective action; and removing the catalyst layer and the layer of graphene from the drum by heating other portions of the catalyst layer.

It is understood that variations may be made in the above without departing from the scope of the invention. While specific embodiments have been shown and described, modifications can be made by one skilled in the art without departing from the spirit or teaching of this invention. The embodiments as described are exemplary only and are not limiting. Many variations and modifications are possible and are within the scope of the invention. Furthermore, one or more elements of the exemplary embodiments may be omitted, combined with, or substituted for, in whole or in part, one or more elements of one or more of the other exemplary embodiments. Accordingly, the scope of protection is not limited to the embodiments described, but is only limited by the claims that follow, the scope of which shall include all equivalents of the subject matter of the claims.

1. A method of manufacturing graphene, comprising:
rotating a drum within an evacuated chamber;
coating the drum with a layer of TaSiN;
coating the layer of TaSiN on the drum with a layer of copper (111);
electro-polishing the layer of copper (111);
heating portions of the layer of copper (111) using focused sunlight;
coating the heated portions of the layer of copper (111) on the drum with a layer of graphene;
monitoring grain growth of the graphene layer;
if the monitored grain growth of the graphene layer indicates more than one grain at a particular location, then reducing heating of the particular location to isolate the grain growth of the particular location and recording the particular location in a memory;
if the monitored grain growth of the graphene layer indicates a single grain surrounded by another single grain at another particular location, then controlling the direction of the rotation of the drum to permit any portions of the layer of copper (111) proximate the particular location missing a grain of graphene to grow a grain of graphene; and
removing the layer of copper (111) and the layer of graphene from the layer of TaSiN on the drum by heating other portions of the layer of copper (111) using focused sunlight.

2. The method of claim 1, wherein heating portions of the layer of copper (111) using focused sunlight comprises controllably focusing concentrated sunlight at a small circular area on the layer of copper (111); and
then increasing the diameter of the heated area on the layer of copper (111) until the heated area includes the opposite edges of the layer of copper (111) on the drum.

3. The method of claim 1, wherein coating the heated portions of the layer of copper (111) on the drum with a layer of graphene comprises rotating the drum after the heated area includes the opposite edges of the layer of copper (111) on the drum.

4. The method of claim 1, wherein monitoring the grain growth of the graphene layer comprises raman spectroscopy of the graphene layer.

5. The method of claim 1, wherein monitoring the grain growth of the graphene layer comprises scanning the graphene layer with an electron microscope.

6. The method of claim 1, wherein removing the layer of copper (111) and the layer of graphene from the layer of TaSiN on the drum by heating other portions of the layer of copper (111) using focused sunlight comprises:
melting the layer of copper (111); and
rolling the layer of graphene onto a roller wheel.

7. The method of claim 6, further comprising:
collecting the melted copper (111); and
recycling the collected copper (111).

8. The method of claim 1, further comprising:
monitoring grain distribution, structure, purity, impurity, and location of such indicia within the graphene layer; and
creating a database of the indicia.

9. A method of manufacturing graphene, comprising:
rotating a drum within an evacuated chamber;
coating the drum with a catalyst layer;
heating portions of the catalyst layer;
coating the heated portions of the catalyst layer with a layer of graphene;
monitoring grain growth of the graphene layer;
if the monitored grain growth indicates unacceptable grain growth, then taking corrective action; and
removing the catalyst layer and the layer of graphene from the drum by heating other portions of the catalyst layer.

10. The method of claim 9, wherein heating portions of the catalyst layer comprises heating portions of the catalyst layer using electromagnetic energy.

11. The method of claim 10, wherein heating portions of the layer of the catalyst layer using electromagnetic energy comprises controllably focusing electromagnetic energy at a small circular area on the catalyst layer; and
then increasing the diameter of the heated area on the catalyst layer until the heated area includes the opposite edges of the catalyst layer on the drum.

12. The method of claim 9, wherein coating the heated portions of the catalyst layer on the drum with a layer of graphene comprises rotating the drum after the heated area includes the opposite edges of the catalyst layer on the drum.

13. The method of claim 9, wherein monitoring the grain growth of the graphene layer comprises raman spectroscopy of the graphene layer.

14. The method of claim 9, wherein if the monitored grain growth indicates unacceptable grain growth, then taking corrective action comprises:
if the monitored grain growth of the graphene layer indicates more than one grain at a particular location, then reducing heating of the particular location to isolate the grain growth of the particular location;
if the monitored grain growth of the graphene layer indicates a single grain surrounded by another single grain at another particular location, then controlling the direction of the rotation of the drum to permit any portions of the catalyst layer proximate the particular location missing a grain of graphene to grow a grain of graphene.

15. The method of claim 9, wherein monitoring grain growth of the graphene layer comprises:
monitoring grain distribution, structure, purity, impurity, and location of such indicia within the graphene layer; and
creating a database of the indicia.

16. A system for manufacturing graphene, comprising:
a housing defining a chamber;
a rotabie drum positioned within the chamber having an exterior surface coated with a catalyst layer;
a motor operably coupled to the drum;
a motor controller operably coupled to the motor for controlling a rate and direction of rotation of the drum;
a source of carbon positioned within the chamber proximate the drum;
a first heating source for heating a first exterior portion of the catalyst layer on the drum;
a monitoring device positioned proximate the first exterior portion of the drum for monitoring a grain growth of graphene on the exterior portion of the catalyst layer on the drum;
a second heating device for heating a second exterior portion of the catalyst layer on the drum; and
a controller operably coupled to the motor, the source of carbon, the first heating source and the second heating source;
wherein the controller is adapted to control the direction and rate of rotation of the motor as a function of the grain growth of graphene on the exterior portion of the catalyst layer on the drum.

17. The system of claim 16, wherein the catalyst layer comprises copper (111)

18. The system of claim 16, wherein the first heating source comprises electromagnetic energy.

19. The system of claim 16, wherein the monitoring device comprises raman spectroscopy.

20. The system of claim 19, wherein the monitoring device comprises an electron microscope.

21. The system of claim 16, wherein the second heating source comprises electromagnetic energy.

22. The system of claim 16, wherein the controller is adapted to reverse the direction of the rotation of the drum in order to ensure complete coverage of the catalyst layer with graphene.

23. The system of claim 16, wherein the controller is adapted to record locations of the layer of graphene having multiple grains.

24. The system of claim 16, further comprising a plurality of CVD assemblies operably coupled to the controller that are deposit one or more layers on materials onto the exterior surface of the drum.

25. The system of claim 16, further comprising:
a database operably coupled to the monitoring device for recording grain distribution, structure, purity, impurity, and location of such indicia within the graphene layer.

26. A method of 3D printing graphene, comprising;
rotating a continuous surface within an evacuated chamber;
coating the surface with a catalyst layer;
heating portions of the catalyst layer;
coating the heated portions of the catalyst layer with one or more layers of graphene;
monitoring grain growth of the graphene layer;
if the monitored grain growth indicates unacceptable grain growth, then taking corrective action; and
removing the catalyst layer and the layer of graphene from the surface by heating other portions of the catalyst layer.

27. The method of claim 26, wherein monitoring grain growth of the graphene layer comprises:
monitoring grain distribution, structure, purity, impurity, and location of such indicia within the graphene layer; and
creating a database of the indicia.

28. A method of manufacturing nanoyarn, comprising:
rotating a drum within an evacuated chamber;
coating the drum with a catalyst layer;
heating portions of the catalyst layer;
coating the heated portions of the catalyst layer with a nanoforest;
monitoring growth of the nanoforest;
if the monitored growth indicates unacceptable growth, then taking corrective action;
removing the catalyst layer and the nanoforest from the drum by heating other portions of the catalyst layer; and
making nanoyarn using the nanoforest.
